(19) United States
(12) Patent Application Publication
(10) Pub. No.: US 2010/0112442 A1
(43) Pub. Date: May 6, 2010

(54) ELECTRODE FOR ELECTROCHEMICAL DEVICE AND ELECTROCHEMICAL DEVICE USING THE SAME

(76) Inventors: Masato Fujikawa, Osaka (JP); Hideharu Takezawa, Nara (JP); Miyuki Nakai, Osaka (JP)

Correspondence Address: MCDERMOTT WILL & EMERY LLP, 600 13TH STREET, NW, WASHINGTON, DC, 20005-3096, US

(21) Appl. No.: 12/594,472

(22) PCT Filed: Oct. 24, 2008
(86) PCT No.: PCT/JP2008/003039

§ 371 Date: Oct. 2, 2009

(30) Foreign Application Priority Data
Oct. 24, 2007 (JP) 2007-276211
Oct. 23, 2008 (JP) 2008-273520

(51) Int. Cl. H01M 4/134; H01M 4/13

(52) U.S. Cl. 429/218.1; 429/209

(57) ABSTRACT

An electrode for an electrochemical device according to the present invention includes a current collector and an active material layer formed on the current collector. The active material layer includes an active material capable of reversibly absorbing and desorbing lithium ions and having a theoretical capacity density of more than 833 mAh/cm³, and the BET specific surface area of the active material layer is 5 m²/g or more and 80 m²/g or less.

### TECHNICAL FIELD

The present invention relates to an electrochemical device and more specifically relates to an improvement of an active material in an electrode for an electrochemical device.

### BACKGROUND ART

In recent years, there has been an increasing demand for lithium ion secondary batteries as a power source for driving portable electronic apparatuses such as mobile phones, digital cameras, video cameras, notebook computers etc. and mobile communication equipment. Among electrochemical devices, non-aqueous electrolyte secondary batteries, which are typically exemplified by lithium ion secondary batteries, are light-weight and have a high electromotive force as well as a high energy density.

In lithium ion secondary batteries, for example, a lithium containing composite oxide is used as a positive electrode active material and a lithium metal or a lithium alloy is used as a negative electrode active material. As a negative electrode, a negative electrode in which a negative electrode mixture layer containing a carbon material (active material) such as graphite and a polymer binder is formed on a current collector is used.

For improving a high-rate discharge characteristic (hereinafter referred to as a high-rate characteristic) and a discharge characteristic under a low-temperature environment (hereinafter referred to as a low-temperature characteristic), one can think of increasing a specific surface area of the negative electrode. When using only an active material such as a carbon material in the negative electrode, one can think of increasing a specific surface area of the carbon material to increase a contact surface area (reaction surface are) of the carbon material with lithium ions.

However, when the contact surface area of the carbon material with lithium ions is increased, the amount of heat generated by the contact of the active material with the electrolyte is increased thereby to deteriorate the safety, the reliability and the self-discharge characteristic of the battery (For example, Non-Patent Document 1). Therefore, in order to balance the high-rate characteristic and the low-temperature characteristic with the safety, the reliability and the self-discharge characteristic, the optimization of the specific surface area of the negative electrode is important.

However, the above evaluation of specific surface area is an evaluation for a negative electrode constituted by a negative electrode active material (carbon material) only and it is not an evaluation for a negative electrode having a negative electrode mixture layer comprising a negative electrode active material and a polymer binder. Also, the battery characteristics are changed according to the types of binders used in the manufacture of the negative electrode and the conditions of compression molding in the formation of the negative electrode mixture layer. For example, a substantial specific surface area is changed according to the degree that the active material is covered with the binder and cracks or collapse of the active material particles in the compression molding.

Therefore, the BET specific surface area of a negative electrode using a negative electrode mixture layer comprising a mixture of a carbon material (active material) and a binder is studied (e.g. Patent Document 1).

In recent years, with a trend for electronic apparatuses having smaller size and exhibiting high performance, there is an increasing demand for electrochemical devices having higher capacity and higher function. However, in the negative electrode having a negative electrode mixture layer containing a carbon material, the capacity of the negative electrode cannot be increased to the amount exceeding the theoretical capacity density of the carbon material. Also, if the specific surface area is increased, the amount of heat generated by the contact of the active material with the electrolyte under a high temperature environment is increased.

In order to realize a higher capacity, researches have been made with regard to a negative electrode active material having a theoretical capacity density of more than 833 Ah/cm³ (hereinafter referred to as negative electrode active material with high capacity) as an alternative for the above negative electrode mixture layer containing a carbon material. It is noted that 833 mAh/cm³ is the theoretical capacity density of graphite (372 mAh/g×2.24 g/cm³). Examples of such an active material include Silicon (Si), tin (Sn) and germanium (Ge) that can alloy with lithium, oxides containing these elements and alloys containing these elements. Among these substances, Si and compounds containing silicon such as silicon oxide have been widely studied because they are inexpensive.

The above negative electrode can be obtained, for example, by forming a thin film of a negative electrode active material having a high capacity on the current collector by the chemical vapor deposition (CVD) method, the sputtering method and the like. However, these negative electrode active materials exhibit a large change in volume because they absorb a large amount of lithium ions at the charge. When the negative electrode active material is Si, Li_{4.4}Si is the state where the most lithium ions are absorbed. The volume of Li_{4.4}Si is 4.12 times larger than that of Si.

Since a negative electrode active material having a high capacity exhibits a large change in volume because of expansion and contraction of the negative electrode active material, when the absorption and desorption of lithium ions i.e. the expansion and contraction of the negative electrode active material are repeated, the adhesion of the negative electrode active material with the negative electrode current collector is decreased thereby to cause generation of cracks on the negative electrode active material layer or separation of the negative electrode active material from the negative electrode current collector. Also, the stress produced by the change in volume of the negative electrode active material may cause creases on the current collector.

A variety of studies have been made on methods for solving the above problems.

For example, Patent Document 2 proposes forming roughness on the surface of the current collector, forming a negative electrode active material layer on the current collector and forming a void in the thickness direction by the etching. Patent Document 3 proposes forming roughness on the surface of the current collector, forming a resist pattern such that the projecting portion becomes an opening portion, and after forming a thin film of a negative electrode active material on the current collector by an electrodeposition, removing the resist to form a columnar body of the active material. Patent Document 4 proposes disposing a mesh on the current collector and forming a negative electrode active material layer in other portion than those corresponding to a frame of the mesh.

Non-Patent Document 1: Solid State Ionics 69 (1994) pp 284-290, Ulrich von Sau Ken

Patent Document 1: Specification of Japanese Patent No. 3139390

Patent Document 2: Japanese Laid-Open Patent Publication No. 2003-17040

Patent Document 3: Japanese Laid-Open Patent Publication No. 2004-127561

Patent Document 4: Japanese Laid-Open Patent Publication No. 2002-279974

### DISCLOSURE OF THE INVENTION

### Problem to be Solved by the Invention

In secondary batteries described in Patent Documents 2 to 4, a negative electrode active material layer comprising a plurality of columnar particles is formed and a void portion is formed between the columnar particles. By this, the stress produced by expansion and contraction (change in volume) of the active material during the charging and discharging is eased thereby to prevent separation of the negative electrode active material layer from the current collector and generation of creases on the current collector.

The effect of a higher capacity is great in the negative electrode using a negative electrode active material with a high capacity: however, in the same manner as above, the problem of the generation of heat in the negative electrode by the contact of the negative electrode with the electrolyte under a high temperature environment has not been solved yet. Also, the relation between the specific surface area of the negative electrode and the amount of heat produced by the contact of the negative electrode with the electrolyte has not been clarified when the negative electrode is constituted by only the negative electrode active material having a higher capacity than the carbon material.

Therefore, in order to solve the above-mentioned conventional problems, the present invention has an object to provide an electrode for an electrochemical device having a high capacity and being superior in the high-rate characteristic, the low-temperature characteristic and the safety, and also an electrochemical device using the same.

### Means for Solving the Problem

The present invention concerns an electrode for an electrochemical device having a current collector and an active material layer formed on the current collector, wherein the active material layer comprises an active material capable of reversibly absorbing and desorbing lithium ions and having a theoretical capacity density of more than 833 mAh/cm³ and wherein the BET specific surface area of the active material layer is 5 m²/g or more and 80 m²/g or less.

It is preferable that the BET specific surface area of the active material layer in the charged state is 0.1 m²/g or more and 5 m²/g or less.

It is preferable that the current collector has a projecting portion on a surface thereof, the active material layer contains at least one columnar particle and the columnar particle is formed on the projecting portion.

It is preferable that the columnar particle is inclined with respect to the normal direction of the current collector.

It is preferable that the columnar particle comprises a stack of particle layers and that the particle layers are inclined with respect to the normal direction of the current collector.

It is preferable that the BET specific surface area of the active material layer is 8 m²/g or more and 50 m²/g or less.

It is preferable that particle layers at steps of odd numbers counted from a bottom portion of the columnar particle are inclined toward a first direction with respect to the normal direction of the current collector and particle layers at steps of even numbers counted from the bottom portion of the columnar particles are inclined toward a second direction with respect to the normal direction of the current collector.

It is preferable that the columnar particle has a plurality of discrete projecting bodies formed on the surface of a side forming an obtuse angle with the surface direction of the current collector.

It is preferable that the BET specific surface area of the active material layer is 50 m²/g or more and 80 m²/g or less.

It is preferable that the angle with which the columnar particle inclines in an acute angle with respect to the surface direction of the current collector is enlarged as lithium ions are absorbed in the columnar particle.

It is preferable that the angle with which the particle layers incline in an acute angle with respect to the surface direction of the current collector is enlarged as lithium ions are absorbed in the particle layers.

It is preferable that the active material comprises a compound represented by the general formula: SiOₓ (provided that 0<x<2).

It is preferable that the columnar particle comprises a compound represented by the general formula: SiOₓ (provided that 0<x<2), and the value x of the columnar particle in the surface direction of the current collector increases from a side forming an acute angle toward a side forming an obtuse angle with the surface direction of the current collector.

It is preferable that the columnar particle comprises a compound represented by the general formula: SiOₓ, (provided that 0<x<2), and the value x in the particle layers increases from a side forming an acute angle forward a side forming an obtuse angle with the surface direction of the current collector.

It is preferable that the surface of the active material layer is subjected to a sandblasting treatment.

It is preferable that the active material layer subjected to a sandblasting treatment has a BET specific surface area of 5 m²/g or more and 8 m²/g or less.

The present invention is also related to an electrochemical device comprising the above-described electrode.

The electrochemical device is a non-aqueous electrolyte secondary battery comprising a positive electrode, a negative electrode and a non-aqueous electrolyte, wherein at least one of the positive electrode and the negative electrode is the above-described electrode.

### EFFECT OF THE INVENTION

The present invention can provide an electrode with a high capacity which is superior in safety because heat generation reaction with an electrolyte at a high temperature is inhibited, and which is at the same time excellent in the high-rate characteristic and the low-temperature characteristic, as well as an electrochemical device using the same.

### BRIEF DESCRIPTION OF THE DRAWINGS

FIG. 1 is a schematic vertical sectional view of a non-aqueous electrolyte secondary battery which is one example of an electrochemical device according to the present invention.

FIG. 2 is a vertical sectional view of an essential portion of a negative electrode according to Embodiment 1 of the present invention.

FIG. 3 is a graph showing changes in the value x in respective particle layers with respect to the surface direction of the negative electrode current collector in the negative electrode according to Embodiment 1 of the present invention.

FIG. 4 is a vertical sectional view of an essential portion showing the state of the negative electrode before the charge according to Embodiment 1 of the present invention.

FIG. 5 is a vertical sectional view of an essential portion showing the state of the negative electrode after the charge according to Embodiment 1 of the present invention.

FIG. 6 is a vertical sectional view of an essential portion showing the state of the columnar particles before the charge.

FIG. 7 is a vertical sectional view of an essential portion showing the state of the columnar particles after the charge.

FIG. 8 is a vertical sectional view of an essential portion of a negative electrode current collector for use in the negative electrode according to Embodiment 1 of the present invention.

FIG. 9 is a vertical sectional view of an essential portion showing the state where a particle layer at a first step is formed on the negative electrode current collector.

FIG. 10 is a vertical sectional view of an essential portion showing the state where a particle layer at a second step is formed on the negative electrode current collector.

FIG. 11 is a vertical sectional view of an essential portion showing the state where a particle layer at a third step is formed on the negative electrode current collector.

FIG. 12 is a vertical sectional view of an essential portion showing a negative electrode wherein columnar particles (particle layers of eight steps) are formed on the negative electrode current collector.

FIG. 13 is a schematic view showing one example of an apparatus for manufacturing a negative electrode according to Embodiment 1 of the present invention.

FIG. 14 is a vertical sectional view showing an essential portion of a negative electrode according to Embodiment 2 of the present invention.

FIG. 15 is a vertical sectional view showing an essential portion of a negative electrode according to Embodiment 3 of the present invention.

FIG. 16 is a vertical sectional view showing an essential portion of a negative electrode current collector for use in a negative electrode according to Embodiment 3 of the present invention.

FIG. 17 is a vertical sectional view of an essential portion showing a process in which a columnar particle grows on the negative electrode current collector.

FIG. 18 is a vertical sectional view of an essential portion showing a process in which projecting bodies are formed on the columnar particle.

FIG. 19 is a vertical sectional view of an essential portion of the negative electrode wherein columnar particles having a plurality of projecting bodies are formed on the negative electrode current collector.

FIG. 20 is a schematic view showing one example of an apparatus for manufacturing a negative electrode according to Embodiment 3 of the present invention.

### BEST MODE FOR CARRYING OUT THE INVENTION

The present invention relates to an electrode for an electrochemical device comprising a current collector and an active material layer formed on the current collector. Also, the present invention is characterized in that the active material layer comprises an active material which can reversibly absorb and desorb lithium ions and which has a theoretical capacity density of more than 833 mAH/cm³, and the active material has a BET specific surface area of 5 m²/g or more and 80 m²/g or less.

With these characteristics, an electrode for an electrochemical device with a high capacity having an improved reliability in which generation of heat caused by a contact with the electrolyte at a high temperature is inhibited, which is at the same time superior in the high-rate characteristic and the low-temperature characteristic.

It is noted that the above BET specific surface area is a value per unit weight of the active material layer. Also, the above BET specific surface area means a BET specific surface area of the active material layer in the state where lithium is not absorbed. Hereinafter, this BET specific surface area is meant when simply a BET specific area is mentioned. The above theoretical capacity density is a theoretical capacity per 1 cm³ of an active material.

When the BET specific surface area of the active material layer is less than 5 m²/g, the contact area of the active material with the electrolyte is decreased to inhibit generation of heat by the contact of the active material with the electrolyte. However, since the ratio of the amount of the active material which contributes to the reaction (active material utilization ratio) in the active material layer is decreased, the high-rate characteristic and the low-temperature characteristic are lowered. When the BET specific surface area of the active material layer is more than 80 m²/g, the contact area of the active material with the electrolyte is enlarged to increase the amount of heat generated by the contact of the active material with the electrolyte, which lowers the reliability.

Further, it is preferable that the BET specific surface area of the active material layer in the charged state is 0.1 m²/g or more and 5 m²/g or less. In such a case, a battery which has a high active material utilization rate and which has an excellent high-rate characteristic and low-temperature characteristic can be obtained. Herein, a charged state refers to a negative electrode in which SOC (state of charge) is 100%. It is to be noted that SOC refers to the ratio of the charged amount relative to the theoretical capacity (fully charged amount) of the negative electrode.

It is preferable that the current collector has projecting portions on a surface thereof and columnar particles are formed on the projecting portions.

It is preferable that the columnar particles are inclined with respect to the normal direction of the current collector.

Herein, the normal direction of the current collector is a direction perpendicular to the main flat surface (also referred to as the surface, simply) of the current collector.

The columnar particles comprise one or more particle layers.

The columnar particles include a stack of particle layers and the particle layers are inclined with respect to the normal direction of the current collector.

It is preferable that the particle layers are stacked such that they are inclined toward a first direction and a second direction alternately with respect to the normal direction of the current collector. That is, it is preferable that the particle layers at steps of odd numbers counted form the bottom portion of the columnar particles are inclined toward the first direction with respect to the normal direction of the surface of the current collector, and the particle layers at steps of even numbers are inclined toward the second direction with respect to the normal direction of the surface area of the active material.

It is preferable that the BET specific surface area of the active material layer constituted by columnar particles comprising particle layers is 8 m²/g or more and 50 m²/g or less.

As described above, by constituting the active material layer with the columnar particles (particle layers), a void portion is easily formed between the neighboring columnar particles, and a space where the non-aqueous electrolyte can move is maintained between the neighboring columnar particles during absorption and desorption of lithium ions.

It is preferable that the columnar particles have a plurality of projecting bodies formed discretely on the surface of a side forming an obtuse angle with the surface direction of the current collector. By this, an active material having a large specific surface area can be obtained and the high-rate characteristic and the low-temperature characteristic can be improved. Herein, the surface direction of the current collector is a direction parallel to the main flat surface (also referred to as the surface, simply) of the current collector.

It is preferable that the BET specific surface area of the active material layer constituted by the columnar particles having projecting bodies is 50 m²/g or more and 80 m²/g or less.

It is preferable that the columnar particles (particle layers) comprise a compound represented by the general formula: SiOₓ (0<x<2). By this, a relatively inexpensive electrode for an electrochemical device having a high electrode reaction efficiency and capacity can be obtained.

It is preferable that the columnar particles (particle layers) inclined with respect to the normal direction of the current collector are formed such that the value x in the above general formula increases from a side forming an acute angle toward a side forming an obtuse angle with the normal direction of the current collector in the surface direction of the current collector. By this, it is possible to protect the columnar particles (particle layers) from mechanical stress based on changes in stress caused by expansion and contraction of the columnar particles (particle layers) during the charging and discharging, and at the same time, it is possible to change reversibly the inclination angle of the columnar particles (particle layers) with respect to the normal direction of the current collector.

In the columnar particles (particle layers), in the case where the value x changes as above, the acute angle formed between the growth direction of the columnar particles (particle layers) and the surface direction of the current collector is enlarged as the columnar particles (particle layers) expand by absorbing lithium ions. Even when the columnar particles (particle layers) expand by absorbing lithium ions, the inclination angle of the columnar particles with respect to the normal direction of the current collector is enlarged and a space where lithium ions can move between the neighboring columnar particles is maintained.

Further, the present invention relates to an electrochemical device comprising the above electrode. By this, an electrochemical device with a high capacity which is superior in the safety, the high-rate characteristic and the low-temperature characteristic can be obtained.

Examples of the electrochemical device include a non-aqueous electrolyte secondary battery such as a lithium ion secondary battery and a capacity device such as a lithium ion capacitor. The non-aqueous electrolyte secondary battery comprises a positive electrode, a negative electrode and a non-aqueous electrolyte, and the above electrode is used in at least one of the positive electrode and the negative electrode.

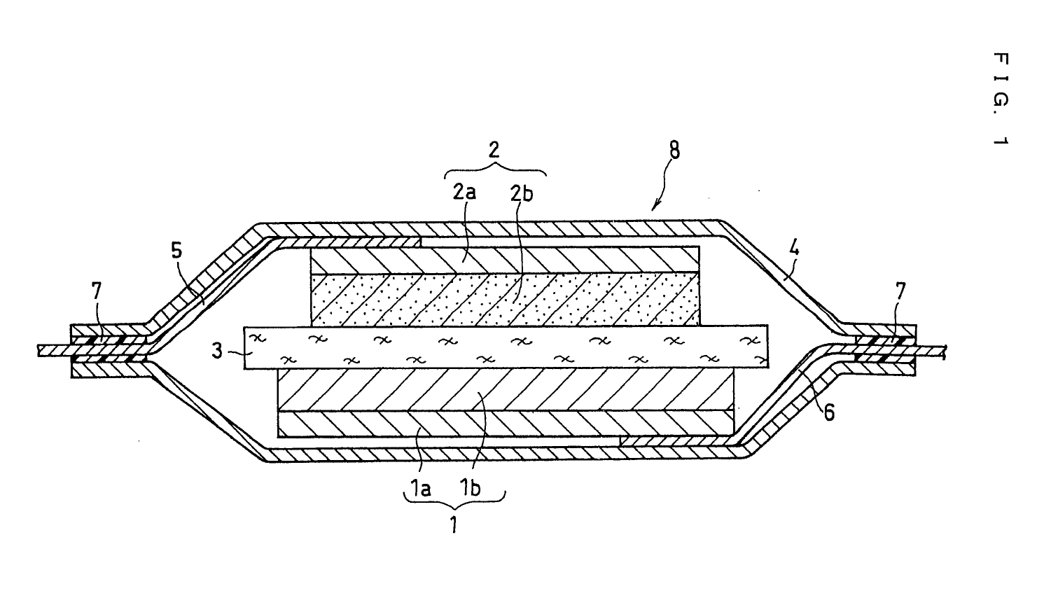

As one example of the electrochemical device according to the present invention, a non-aqueous electrolyte secondary battery using the above electrode as the negative electrode will be described with reference to drawings. FIG. 1 is a schematic vertical sectional view of a non-aqueous electrolyte secondary battery as one example of the electrochemical device according to the present invention.

As shown in FIG. 1, a stacked type non-aqueous electrolyte secondary battery 8 includes an electrode group comprising a negative electrode 1, a positive electrode 2 and a separator interposed therebetween. The electrode group and an electrolyte having lithium ion conductivity are housed inside an exterior case 4. The separator 3 is impregnated with the electrolyte having lithium ion conductivity. The negative electrode 1 includes a negative electrode current collector 1a and a negative electrode active material layer 1b formed on the negative electrode current collector 1a. The positive electrode 2 includes a positive electrode current collector 2a and a positive electrode active material layer 2b formed on the positive electrode current collector 2a. The positive electrode current collector 2a and the negative electrode current collector 1a are connected respectively to one end of a positive electrode lead 5 and one end of a negative electrode lead 6, and other end of the positive electrode lead 5 and other end of the negative electrode lead 6 are guided outside the exterior case 4. Further, an opening portion of the exterior case 4 is sealed with a resin material 7. As the exterior case 4, for example a sheet of a resin film laminated with an aluminum foil is used.

The positive electrode active material layer 2b desorbs lithium during the charging and absorbs lithium desorbed by the negative electrode active material layer 1b during the discharging. The negative electrode active material layer 1b absorbs lithium desorbed by the positive electrode active material layer 2b during the charging and desorbs lithium during the discharging. The negative electrode active material layer 1b comprises a negative electrode active material capable of reversibly absorbing and desorbing lithium ions and having a theoretical capacity density of more than 833 Ah/cm³.

The BET specific surface area of the negative electrode active material layer 1b is 5 m²/g or more and 80 m²/g or less per unit weight of the negative electrode active material. In case the BET specific surface area of the negative electrode active material layer 1b is less than 5 m²/g, the contact surface area of the negative electrode active material with the electrolyte is small and thus heat generation reaction with the electrolyte is inhibited; however, since the ratio of the amount of the active material contributing to the reaction in the negative electrode active material layer (utilization ratio of negative electrode active material) is lowered, the high-rate characteristic as well as the low-temperature characteristic are deteriorated. In case the BET specific surface area of the negative electrode active material layer 1b is more than 80 m²/g, the contact surface area of the negative electrode active material with the electrolyte is enlarged and the amount of heat produced by the reaction with the electrolyte is increased, thereby considerably lowering the reliability such as the safety.

Examples of the negative electrode active material having a theoretical capacity density of more than 833 mAh/cm³ include a simple substance of silicon (Si), a material containing silicon, a simple substance of tin (Sn) and a material containing tin. As the material containing silicon, SiOₓ (0<x<2) is preferable. Also, as the material containing silicon, an alloy, a compound, or a solid solution containing Si and at least one element selected from the group consisting of Al, In, Cd, Bi, Sb, B, Mg, Ni, Ti, Mo, Co, Ca, Cr, Cu, Fe, Mn, Nb, Ta, V, W, Zn, C, N and Sn. Examples of the material containing tin include Ni₂Sn₄, Mg₂Sn, SnOₓ(0<x<2), SnSiO₃ and LiSnO.

These active materials can be used singly or in combination of two or more of them. For example, a compound containing Si, oxygen and nitrogen, a mixture or a composite of two or more compounds containing Si and oxygen and having a different composition ratio of Si and oxygen can be used.

As the negative electrode current collector 1a, a metal foil such as stainless steel, nickel, copper and titanium and a thin film of carbon or an electrically conductive resin can be used. Further, the above metal foil or thin film may be coated with carbon, nickel, or titanium on the surface thereof.

The positive electrode active material layer 2b can be constituted by a positive electrode active material only or it can be constituted by a positive electrode mixture comprising a positive electrode active material, a conductive agent and a binder.

As the positive electrode active material, for example lithium-containing composite oxides such as LiCoO₂, LiNiO₂ and Li₂MnO₄ are used. Also, as the positive electrode active material, olivine-type lithium phosphate represented by the general formula: LiMPO₄ (wherein M is at least one element selected from the group consisting of V, Fe, Ni and Mn) and lithium fluorophosphate represented by the general formula: Li₂MPO₄F (wherein M is at least one element selected from the group consisting of V, Fe, Ni and Mn) can be used. Further, elements constituting the above compounds can be replaced with foreign elements. The surface of the positive electrode active material may be coated with a metal oxide, lithium oxide or a conductive agent, or may be treated to obtain hydrophobicity.

Examples of the conductive agent include graphite such as natural graphite and artificial graphite; carbon black such as acetylene black, ketjen black, channel black, furnace black, lump black and thermal black; conductive fiber such as carbon fiber and metallic fiber; fluorinated carbon; metallic powder such as aluminum; conductive whisker such as zinc oxide and potassium titanate; conductive metal oxide such as titanium oxide; organic conductive material such as phenylene derivative and the like.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyethersulfone, hexafluoropolypropylene, styrene-butadiene rubber and carboxymethyl cellulose. As the binder, two or more copolymers selected from the group consisting of tetrafluoroethylene, hexafluoropropylene, perfluoroalkyl vinyl ether, vinylidene fluoride, chlorotrifluoroethylene, ethylene, propylene, pentafluoropropylene, fluororomethyl vinyl ether, acrylic acid and hexadiene can be used. These copolymers can be used singly or in combination of two or more of them.

As the positive electrode current collector 2a, for example aluminum, a carbon material and a conductive resin can be used. These materials can be coated with carbon.

As the separator 3, a nonwoven fabric and a microporous film can be used. Examples of the material of the separator 3 include polyethylene, polypropylene, aramid resin, amide-imide, polyphenylene sulfide and polyimide. The separator 3 can include a heat-resistant filler such as alumina, magnesia, silica and titania. Further, a heat-resistant layer including a filler and the above binder can be disposed between the separator and the electrode.

The separator 3 comprises a non-aqueous electrolyte. The non-aqueous electrolyte comprises, for example, an organic solvent and a lithium salt dissolved in the organic solvent.

Examples of the lithium salt include LiPF₆, LiBF₄, LiClO₄, LiAlCl₄, LiSbF₆, LiSCN, LiCF₃SO₃, LiNCF₃CO₂, LiAsF₆, LiB₁₀Cl₁₀, lithium lower aliphatic carboxylates, LiF, LiCl, LiBr, LiI, chloroborane lithium, lithium bis(1,2-benzen dioleate(2-)-O,O′)borate, lithium bis(2,3-naphtalene dioleate(2-)-O,O′)borate, lithium bis(2,2′-biphenyl dioleate (2-)-O,O′)borate, lithium bis(5-fluoro-2-oleate-1-benzen sulfonate-O,O′)borate, (CF₃SO₂)₂NLi, LiN(CF₃SO₂)(C₄F₉SO₂), (C₂F₅SO₂)₂NLi and lithium tetraphenylborate.

Examples of the organic solvent include ethylene carbonate (EC), propylene carbonate, butylene carbonate, vinylene carbonate, dimethyl carbonate (DMC), diethyl carbonate, ethyl methyl carbonate (EMC), dipropyl carbonate, methyl formate, methyl acetate, methyl propionate, ethyl propionate, dimethoxymethane, γ-butyrolactone, γ-valerolactone, 1,2-diethoxyethane, 1,2-dimethoxyethane, ethoxy-methoxyethane, trimethoxymethane, tetrahydrofuran derivatives such as tetrahydrofuran and 2-methyl-tetrahydrofuran, dimethyl sulfoxide, dioxolane derivatives such as 1,3-dioxolane and 4-methyl-1,3-dioxolane, formamide, acetoamide, dimethyl formamide, acetonitrile, propyl nitrile, nitromethane, ethyl monoglyme, phosphoric acid triester, acetic acid ester, propionic acid ester, sulfolane, 3-methylsulfolane, 1,3-dimethyl-2-imidazolidinone, 3-methyl-2-oxazolidinone, propylene carbonate derivatives, ethyl ether, diethyl ether, 1,3-propane sultone, anisole and fluorobenzene. These substances can be used singly or in combination of two or more of them.

It is possible to add, further to the above non-aqueous electrolyte, additives such as vinylene carbonate, cyclohexylbenzene, biphenyl, diphenyl ether, vinyl ethylene carbonate, divinyl ethylene carbonate, phenyl ethylene carbonate, diallyl carbonate, fluoroethylene carbonate, catechol carbonate, vinyl acetate, ethylene sulfite, propane sultone, trifluoropropylene carbonate, dibenzofuran, 2,4-difluoroanisol, o-terphenyl, m-terphenyl and the like.

As the non-aqueous electrolyte, an organic solvent, a lithium salt which can dissolve in an organic solvent and a so-called polymer electrolyte layer non-fluidized with a polymer material can be used.

As the non-aqueous electrolyte, a solid electrolyte comprising the above lithium salt and a polymeric material can be used. Examples of the polymeric materials include polyethylene oxide, polypropylene oxide, polyphosphazen, poly aziridine, polyethylene sulfide, polyvinyl alcohol, polyvinylidene fluoride and polyhexafluoropropylene. These materials can be used singly or in combination of two or more of them.

As the solid electrolyte, in addition to the above, inorganic materials such as lithium nitrides, lithium halides, lithium oxoates, Li₄SiO₄, Li₃PO₄—Li₄SiO₄, Li₂SiS₃, Li₃PO₄—Li₂S—SiS₂, phosphorous sulfide compound and the like can be used.

As the non-aqueous electrolyte, a gel electrolyte comprising the above organic solvent, a lithium salt, and a polymeric material can be used. When using the gel electrolyte, the gel electrolyte may be disposed between the negative electrode 1 and the positive electrode 2 in place of the separator 3. Alternatively, the gel electrolyte may be disposed adjacent to the separator 3.

Preferred embodiments of the negative electrode for the non-aqueous electrolyte secondary battery will be described in the following.

### Embodiment 1

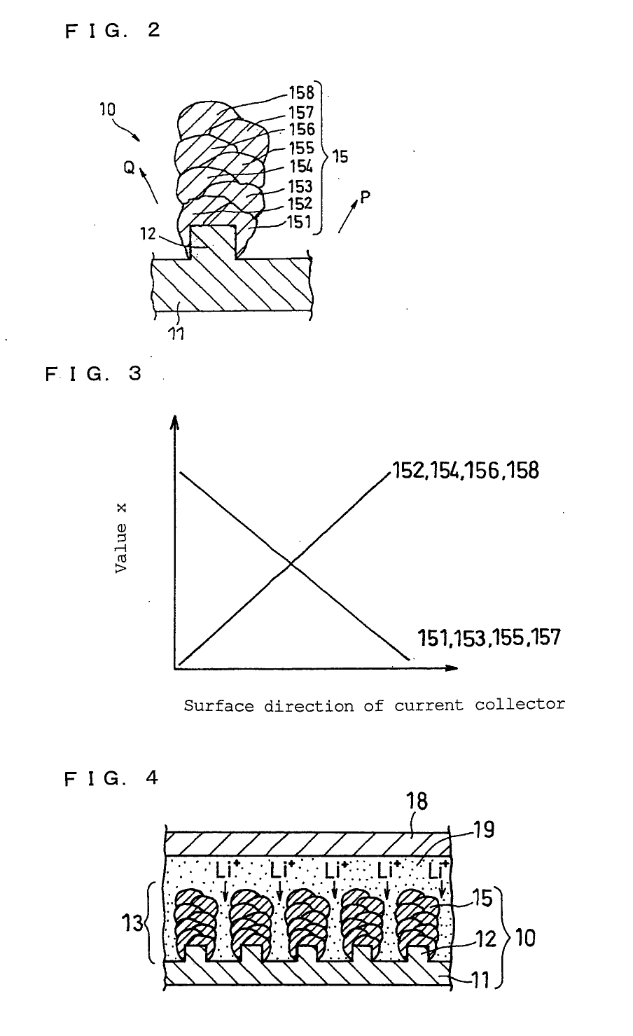

The negative electrode for the non-aqueous electrolyte secondary battery according to this embodiment will be described with reference to FIG. 2. FIG. 2 is a vertical sectional view showing an essential portion of the negative electrode for the non-aqueous electrolyte secondary battery according to the present embodiment.

As shown in FIG. 2, a negative electrode 10 comprises a negative electrode current collector 11 having a projecting portion 12 on one surface thereof and a columnar particle 15 formed on the projecting portion 12. The columnar particle 15 comprises a stack of eight particle layers 151, 152, 153, 154, 155, 156, 157 and 158.

The particle layers 151, 153, 155 and 157 at steps of odd numbers (first, third, fifth and seventh steps) counted from the bottom portion of the columnar particle 15 are inclined to a first direction P with respect to the normal direction of the current collector. The particle layers 152, 154, 156 and 158 at steps of even numbers (second, fourth, sixth and eighth steps) counted from the bottom portion of the columnar particle 15 are inclined to a second direction Q which is different from the first direction with respect to the normal direction of the current collector 11. In this manner, the inclination directions of the respective particle layers constituting the columnar particle 15 with respect to the normal direction of the current collector 11 change alternately between the first direction and the second direction according to their number of steps.

The first direction P and the second direction Q have the same angle of inclination with respect to the normal direction of the current collector, and in case the length in the growth direction of the particle layers of the respective steps is the same, the average growth direction of the columnar particle 50 as the entire particle can be almost parallel to the normal direction of the surface of the current collector.

In order to improve the reliability by inhibiting generation of heat by the contact of the negative electrode with the electrolyte at a high temperature, and to obtain an excellent high-rate characteristic and low-temperature characteristic, a negative electrode active material layer 13 constituted by the columnar particle 15 comprising particle layers has a BET specific surface area of 8 m²/g or more and 50 m²/g or less. It is more preferable that the negative electrode active material layer 13 has a BET specific surface area or 10 m²/g or more and 30 m²/g or less.

It is preferable that the negative electrode active material layer 13 in the charged state has a BET specific surface area of 0.1 m²/g or more and 5 m²/g or less, and more preferably 0.17 m²/g or more and 3.5 m²/g or less.

The respective particle layers (columnar particles) formed inclined on the current collector is obtained by depositing a material constituting the particle layers from above and oblique to the normal direction of the current collector using the spattering method or the vacuum deposition method. The specific surface area of the active material layer can be controlled by adjusting the number of steps of the particle layers, the shapes of the columnar particles and the number of the columnar particles per unit area of the current collector.

For example, in SiO_{0.3}, an active material layer having a BET specific surface area of 8 m²/g can be obtained by forming 500 columnar particles having 40 steps of particle layers per 1 mm² of the current collector. For example, in SiO_{0.6}, an active material layer having a BET specific surface area of 50 m²/g can be obtained by forming 500 columnar particles having 2 steps of particle layers per 1 mm² of the current collector.

The respective particle layers comprise SiOₓ (0<x<2).

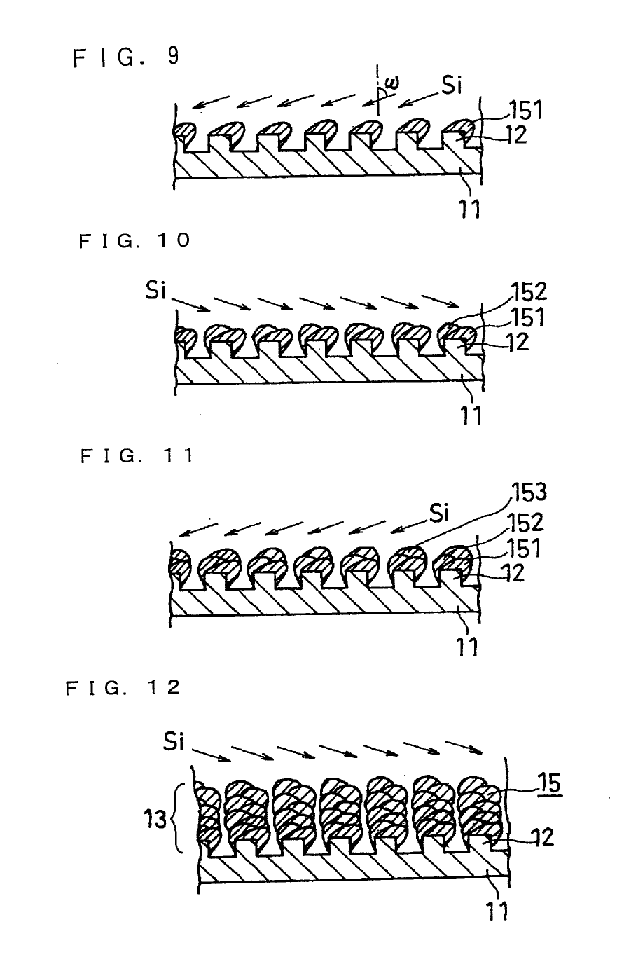

FIG. 3 shows changes in the value x (oxygen content ratio) in SiOₓ in the respective particle layers with respect to the surface direction of the current collector of respective particle layers (direction A-A in FIG. 2). As shown in FIGS. 3, 8 particle layers 151, 152, 153, 154, 155, 156, 157 and 158 are formed such that the value x becomes larger from the side forming an acute angle to the side forming an obtuse angle with the surface direction of the negative electrode current collector. That is, the particle layers 151, 153, 155 and 157 at steps of odd numbers have a decrease in the value x from left to right in FIG. 3 (direction A-A in FIG. 2), whereas the particle layers 152, 154, 156 and 158 at steps of even numbers have an increase in the value x from left to right in FIG. 3 (direction A-A in FIG. 2). In this manner, the particle layers at steps of odd numbers have a direction of oxygen concentration gradient that is opposite to that of the particle layers at steps of even numbers. It is to be noted in FIG. 3 that although the change in the amount of x with respect to the direction A-A (gradient) is constant in FIG. 2, the amount of change (gradient) may not be constant.

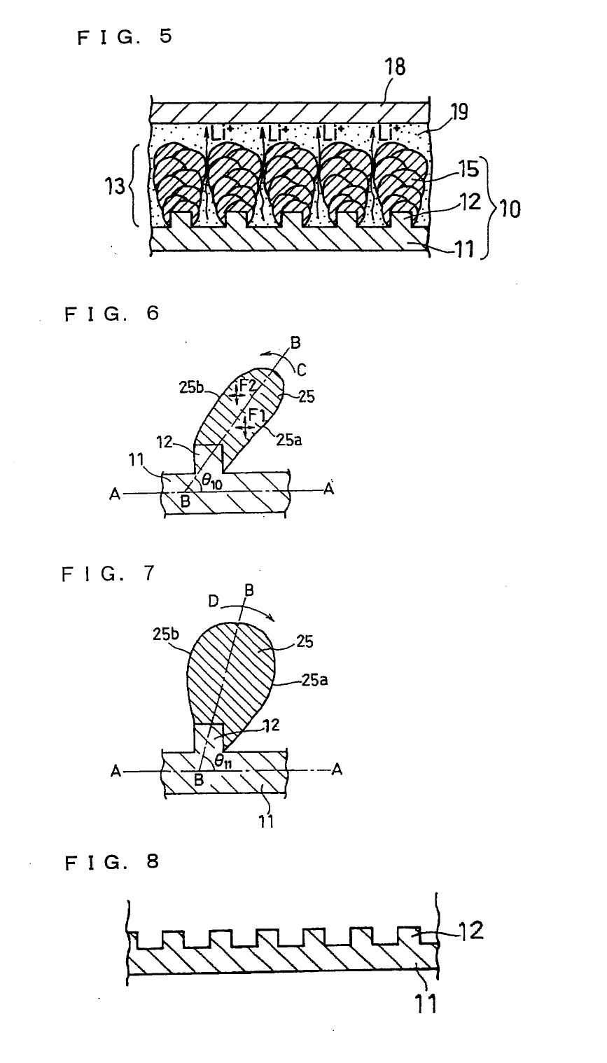

Herein, FIG. 4 is a schematic view showing the state of the battery before the charge (early period of charge) and FIG. 5 is a schematic view showing the state of the battery after the charge. Although a separator is disposed between the positive electrode and the negative electrode, the separator is omitted and not shown in FIGS. 4 and 5.

As shown in FIG. 4, at an early stage of the charge, the entire surface exposed to the outside of the columnar particles 15 can absorb lithium ions supplied from a positive electrode 18 and moving in an electrolyte 19. As shown in FIG. 5, the columnar particles 15 absorb lithium ions and expand as the charge goes on.

Then, after the columnar particles 15 desorb lithium ions during the discharging, the columnar particles 15 return to their size before the charge (early stage of the charge). The negative electrode active material layer 13 before the charge as shown in FIG. 4 has a BET specific surface area of as large as 8 m²/g or more and 50 m²/g or less. However, by constituting the negative electrode active material layer 13 with columnar particles 15, the amount of heat generated by the contact of the negative electrode with the electrolyte under a high temperature environment of about 150° C., for example can be decreased to about one fifth of the amount of heat generated, in a conventional negative electrode.

The columnar particles 15 have bump-shaped projecting portions on their sides because of inclination of the respective particle layers constituting the columnar particles with respect to the normal direction of the current collector 11. When one sees the negative electrode 10 from the side of the positive electrode 18, concave portions formed between the projecting portions 12 of the current collector 11 are partially hidden by these projecting portions. Consequently, most of the lithium ions desorbed by the positive electrode 18 during the charging are caught by the projecting portions of the columnar particles 15 between the neighboring columnar particles 15 and absorbed inside the columnar particles 15. In this manner, since lithium ions desorbed by the positive electrode 18 at the charge are prevented from reaching directly to the concave portions of the current collector 11 that are exposed between the columnar particles 15, direct deposition of lithium metal on the current collector 11 is inhibited.

Also, the inclination angle of the respective particle layers of the columnar particles 15 with respect to the surface direction of the current collector 11 changes reversibly by absorption and desorption of lithium ions. Specifically, at the charge, as the columnar particles 15 absorb lithium ions and expand, the inclination angle of the respective particle layers with respect to the surface direction of the current collector 11 is enlarged and the respective particle layers stand up. On the other hand, at the discharge, as the columnar particles 15 desorb lithium ions and contract, the inclination angle of the respective particle layers with respect to the surface direction of the current collector 11 is reduced and the respective particle layers incline.

As shown in FIG. 5, after the charge, the respective particle layers constituting the columnar particles 15 are expanded and the inclination angle of the respective particle layers with respect to the surface direction of the current collector 11 is enlarged. In consequence, the respective particle layers almost stand up on the current collector 15 and the projection of the projecting portions on the side of the columnar particles 15 are reduced. As a result, as illustrated by arrows in FIG. 5, even when the columnar particles 15 expand, a space where an electrolyte 19 (lithium ions) can move is secured between the columnar particles 15 because of enlargement of the inclination angle of the respective particle layers with respect to the surface direction of the current collector 11. At the charge as well as at the discharge, lithium ions can move easily because the electrolyte 19 circulates through the space between the columnar particles 15. By this, generation of heat by the contact of the negative electrode active material layer 13 with the electrolyte is inhibited, and also the effect of increasing greatly the high-rate characteristic and low-temperature characteristic can be obtained remarkably. Also, since the negative electrode active material layer 13 has a void between the columnar particles 15, stress generated with expansion and contraction (change in volume) of the active material at the charge and discharge is reduced, and therefore separation of the negative electrode active material layer 13 from the current collector 11 and occurrence of creases on the current collector 11 can be prevented.

Herein, the mechanism that the inclination angle of the respective particle layers of the columnar particles 15 with respect to the surface direction of the current collector 11 changes reversibly with absorption and desorption of lithium ions will be described with reference to FIGS. 6 and 7. It is noted that although the columnar particles 15 in FIGS. 4 and 5 are constituted by the particle layers of eight steps, the case where the columnar particles are constituted by one particle layer is described here for simplifying the explanation. FIG. 6 is a schematic view illustrating the state of a columnar particle (one particle layer) before the charge, and FIG. 7 is a schematic view illustrating the state of a columnar particle (one particle layer) after the charge.

As shown in FIG. 6, a columnar particle 25 is formed on the projecting portion 12 on the current collector 11 such that it is inclined with respect to the normal direction (surface direction) of the current collector 11. The inclination angle in an acute angle formed between the growing direction (direction B-B) of the columnar particle 25 and the surface direction (direction A-A) of the current collector 11 is θ₁₀. The columnar particle 25 comprises SiOₓ (0<x<2). The columnar particle 25 is formed such that the value x (content ratio of oxygen atoms) in SiOₓ (0<x<2) increases gradually from a lower side 25a forming an acute angle with the surface direction of the current collector 11 toward an upper side 25b forming an obtuse angle with the surface direction of the current collector 11. Larger the value x in SiOₓ is, the smaller the amount of expansion of SiOₓ becomes with absorption of lithium ions.

At an early stage of the charge, the columnar particle 25 expands by absorbing lithium ions in the columnar particle and stress by the expansion is produced inside the columnar particle. As illustrated in FIG. 6, since the value x increases from the lower side 25a toward the upper side 25b, the expansion stress produced by the expansion of the columnar particle decreases continuously from an expansion stress F1 on the lower side 25a to an expansion stress F2 on the upper side 25b. As shown in FIGS. 6 and 7, owing to the gradient of stress in expansion, the inclination angle in an acute angle formed between the growing direction (direction B-B) of the columnar particle 25 and the surface direction (direction A-A) of the current collector 11 increases from angle θ₁₀ to θ₁₁ and the columnar particle 25 stands up toward the direction shown by an arrow C in FIG. 6. The angle θ₁₁ is larger than the angle θ₁₀ and the angle θ₁₀ is for example 30 to 60° and the angle θ₁₁ is for example 45 to 80°.

On the other hand, at the discharge, since the columnar particle 25 contracts by desorbing lithium ions, stress inside the columnar particle 15 is reduced and the columnar particle 25 returns to the state before the charge. That is, the inclination angle of the columnar particle 25 decreases from θ₁₁ to θ₁₀ and the columnar particle 25 inclines toward the direction shown by an arrow D in FIG. 7.

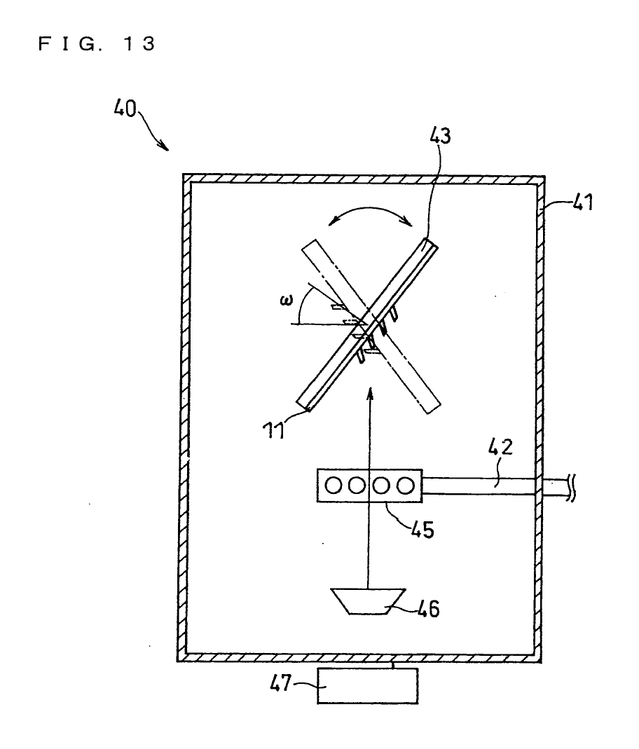

A method for manufacturing the negative electrode according to this embodiment will be described with reference to FIGS. 8 to 13. FIGS. 8 to 12 are schematic views showing a manufacturing process of the negative electrode according to this embodiment. FIG. 13 is a schematic view showing one example of a manufacturing apparatus of the negative electrode according to this embodiment.

As illustrated in FIG. 13, a manufacturing apparatus 40 comprises a vacuum chamber 41 controlling the atmosphere inside the apparatus 40, an electron beam generating apparatus (not illustrated) as a heating means, a gas introduction pipe 42 for introducing an oxygen gas into the vacuum chamber 41 and a fixture stand 43 for fixing the current collector 11. A vacuum pump 47 for reducing the pressure inside the vacuum chamber 41 is disposed in the manufacturing apparatus 40. A nozzle 45 for discharging an oxygen gas toward the current collector inside the vacuum chamber 41 is disposed on an edge portion of the gas introduction pipe 42, and the fixture stand 43 is arranged on the upper side of the nozzle 45. A deposition source 46 containing a material for depositing on the current collector is arranged on the lower side of the fixture stand 43. The positional relation between the current collector and the deposition source 46 can be changed according to the angle of the fixture stand 43. That is, the inclination angle of the columnar particles with respect to the normal direction of the current collector can be controlled by adjusting an angle ω formed between the normal direction of the current collector 11 (fixture stand 43) and the horizontal direction.

In the following, one example of a specific procedure will be described. One example of forming a negative electrode active material layer comprising SiOₓ will be described using Si as the deposition source 46.

First, as shown in FIG. 8, a current collector 11 made of a belt-shaped electrolytic copper foil (e.g. 30 μm in thickness) having a plurality of projecting portions 12 (e.g. 7.5 μm in height, 20 μm in width and 20 μm interval) on one surface is prepared. The projecting portions 12 can be formed by the plating method, for example. This current collector 11 is fixed on the fixture stand 43. The angle ω (e.g. 60°) formed between the normal direction of the current collector 11 on the fixture stand 43 and the horizontal line is adjusted. The atmosphere inside the vacuum chamber 41 is adjusted. For example, the inside of the vacuum chamber 41 is adjusted to a prescribed atmosphere (e.g. an oxygen atmosphere of pressure of 3.5 Pa). Si (e.g. scrap silicon of 99.999% in purity) is prepared as the deposition source 46.

By projecting an electron beam onto the deposition source 46, Si is heated and vaporized. The vaporized Si is projected to the current collector 11 from the direction of an arrow in FIG. 9 and an oxygen gas is supplied from the nozzle 45 toward the current collector 11. Silicon is bonded to oxygen to deposit SiOₓ (active material) on the current collector. Then, a particle layer 151 at the first step inclined with an angle ω with respect to the normal direction of the current collector 11 is formed. The height of the particle layer 151 in the normal direction of the current collector is 2.5 for example. At this time, the value x in SiOₓ changes continuously relative to the surface direction (direction A-A) of the current collector 11. In the particle layer 151 in FIG. 9, the value x increases from the right side toward the left side. The range of the value x is 0.01 to 1.95 for example.

These changes in the value x are considered to be caused by a shadow effect of the particle layers which are formed inclined on the current collector with a certain interval. Although most of the oxygen gas supplied to the current collector reaches the tip portions of the particle layers, a part thereof reaches a side surface of the particle layers. Most of the oxygen gas reaching the side surface of the particle layers does not reach the surface of the side forming an acute angle with the surface direction of the current collector, but reaches to the surface of the side forming an obtuse angle with the surface direction of the current collector. For this reason, it is considered that the oxygen content ratio on the side forming an obtuse angle with the surface direction of the current collector is higher than on the side forming an acute angle with the surface direction of the current collector.

Also, in the surface direction of the particle layers, the value x can be changed by changing the amount of Si and the oxygen gas supplied to the current collector from the side forming an acute angle to the side forming an obtuse angle with the surface direction of the current collector.

Next, by rotating the fixture stand 43, the current collector 11 with the particle layer 151 formed on the projecting portions 12 is adjusted to the position as shown by a dot and dashed line in FIG. 13, that is the position of angle (180-ω) (e.g. 120°) formed between the normal direction of the fixture stand 43 (current collector 11) and the horizontal direction. Then, an electron beam is projected to the deposition source to vaporize Si. The vaporized Si is incident on the particle layers 151 on the current collector 11 from the direction of the arrows in FIG. 10 while supplying an oxygen gas from the nozzle 45 toward the current collector 11.

Silicon is bonded to oxygen to deposit SiOₓ (active material) on the current collector. Then, on the particle layers 151 of the current collector 11, particle layers 152 at the second step is formed inclined to the direction of angle (180-ω) with respect to the normal direction of the current collector 11. The height of the particle layers 152 in the normal direction of the current collector is 2.5 μm, for example. The particle layers 151 at the first step have an inclination direction with respect to the normal direction of the current collector as well as a gradient direction of the value x in the normal direction of the current collector 11 that are opposite to those of the particle layers 152 at the second step.

The fixture stand 43 is returned to the position as shown by the solid line in FIG. 13. As shown in FIG. 11, particle layers 153 at the third step are formed on the particle layers 152 under the same conditions as in the particle layers at the first step. Then, particle layers at the fourth to eighth steps are formed sequentially. The particle layers at the fourth, sixth and eighth steps are formed under the same conditions as in the particle layers at the second step. The particle layers at the fifth and seventh steps are formed under the same conditions as in the particle layers at the first step.

In this manner, the columnar particles 15 comprising a stack of particle layers of eight steps are formed. The particle layers at steps of odd numbers (first, third, fifth and seventh stages) have an inclination direction with respect to the normal direction of the current collector as well as a gradient direction of the x value in the normal direction of the current collector which are opposite to those of the particle layers at steps of even numbers.

Although the number of steps is eight in the above, it is noted that the number of steps is not restricted thereto. According to the number of steps, the manufacturing process of the particle layers 151 and the manufacturing process of the particle layers 152 may be carried out alternately. Further, although this embodiment describes the case of forming projecting portions and the negative electrode active material layer on one surface of the current collector, it is possible to form projecting portions and the negative electrode active material layer on both surfaces of the current collector.

### Embodiment 2

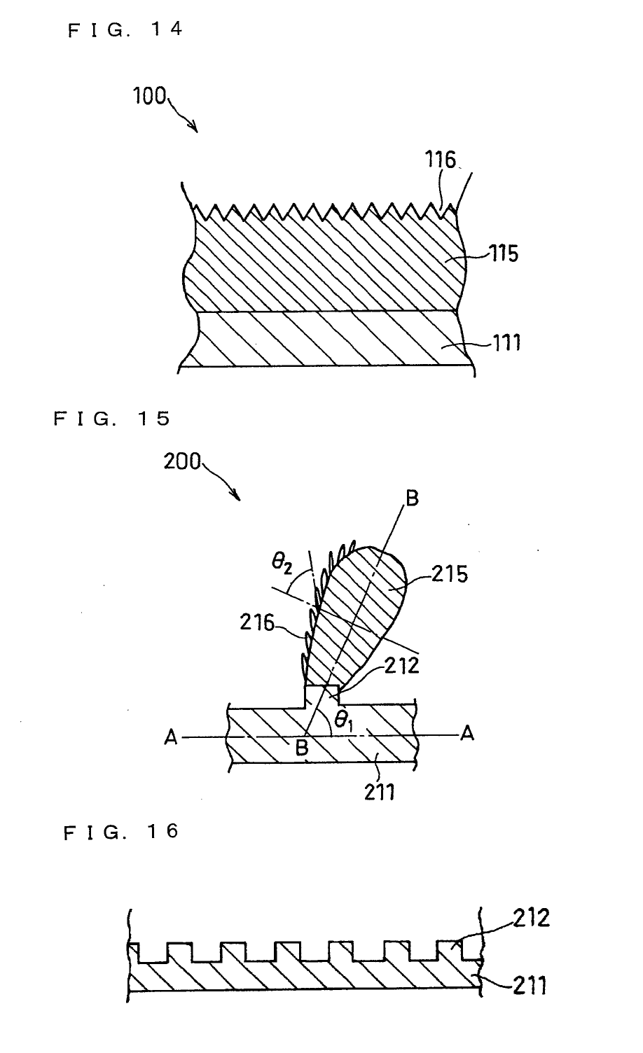

An electrode for a non-aqueous electrolyte secondary battery according to this embodiment will be described with reference to FIG. 14. FIG. 14 is a vertical sectional view of an essential portion of a negative electrode according to this embodiment.

As shown in FIG. 14, an electrode 100 comprises a negative electrode current collector 111, and a negative electrode active material layer 115 covering the surface of the negative electrode current collector 111. As the negative electrode active material, SiOₓ (0<x<2) is preferable. The negative electrode active material layer 115 does not have a void portion to which a part of the current collector 111 is exposed but covers densely the surface of the current collector 111. On the surface of the negative electrode active material layer 115, rough portions 116 are formed. It is preferable that this negative electrode active material layer 115 has a BET specific surface area of 5 m²/g or more and 8 m²/g or less. It is more preferable that the negative electrode active material 115 has a BET specific surface area of 5.5 m²/g or more and 7.5 m²/g or less. Also, it is preferable that the negative electrode active material layer 115 in the charged state has a BET specific surface area of 0.1 m²/g or more and 1.7 m²/g or less.

The negative electrode 100 is obtained by forming a negative electrode active material layer having a smooth surface on the negative electrode current collector 111 by the spattering method or vacuum deposition method, and then forming roughness on the surface of the negative electrode active material layer by the sandblasting method or the etching method. As the negative electrode current collector 111, for example a metal foil having a surface roughness Ra of 0.1 to 10 μm is used.

The sandblasting method is a surface treatment method in which a high-pressure gas containing particles in the form of sand is sprayed onto the surface of a material. In the sandblasting method, the specific surface area of the active material layer can be controlled by adjusting the types of abrasives used and the time of the blast treatment.

In the etching method, the specific surface area of the active material layer can be controlled by adjusting the concentration of the etching liquid and the time of immersing in the etching liquid.

Although it is possible to form the rough portions 16 on the negative electrode active material layer 115 such that the BET specific surface area is more than 8 m²/g, it is preferable to constitute the negative electrode active material layer with the columnar particles from the viewpoint of processability and readiness in adjusting the BET specific surface area.

By using the negative electrode with the above constitution, in spite of a large specific surface area, the amount of heat generated by the contact of the negative electrode with the electrolyte at a high temperature can be reduced to about ⅙ to 1/10 of the case in which a conventional negative electrode is used. Since the specific surface area is large, an excellent high-rate characteristic and low-temperature characteristic can be obtained.

### Embodiment 3

A negative electrode for a non-aqueous electrolyte secondary battery according to this embodiment will be described with reference to FIG. 15. FIG. 15 is a vertical sectional view showing an essential portion of the negative electrode according to this embodiment.

As shown in FIG. 15, a negative electrode 200 has a columnar particle 215 formed on a projecting portion 212 on the surface of the current collector 211 such that it inclines with respect to the normal direction of the current collector 211. The columnar particle 215 has a plurality of projecting bodies 216 formed discretely on the surface of the side forming an obtuse angle with the surface direction of the current collector 211. The plurality of projecting bodies 216 are scattered on the surface of the current collector without overlapping each other. More specifically, the plurality of projecting bodies 216 are formed discretely on the surface of the side forming an obtuse angle θ₁ with the surface direction (direction A-A) of the current collector 11 in the growth direction (direction B-B) of the columnar particle 215. The plurality of projecting bodies 216 incline with angle θ₂ with respect to the direction perpendicular to the growth direction (direction B-B) of the columnar particle 215 and extend from the surface of the columnar particle 215 away from the current collector 211. It is preferable that angle θ₁ is 30 to 60°. Angle θ₂ is 45 to 85°, for example.

The projecting bodies 216 are columnar, for example, and they are smaller than the columnar particle 215. The projecting bodies 216 may be in a shape other than columnar. The projecting bodies 216 are, for example, 1/10000 to 1/20 of the columnar particle 215. The columnar particle 215 has a length in the growth direction of 1 to 100 μm, for example. The projecting bodies 216 have a length in the growth direction of 0.1 to 50 μm, for example. The columnar particle 215 has a section perpendicular to the growth direction of 1 to 100 μm in diameter, for example. The projecting bodies 216 have a section perpendicular to the growth direction of 0.1 to 10 μm in diameter, for example.

It is preferable that a negative electrode active material layer 213 has a BET specific surface area of 50 m²/g or more and 80 m²/g or less. It is more preferable that the negative electrode active material layer 213 has a BET specific surface area of 55 m²/g or more and 75 m²/g or less. Also, it is preferable that the negative electrode active material layer 213 in the charged state has a BET specific surface area of 3.5 m²/g or more and 5 m²/g or less.

By using the above negative electrode 200, generation of heat by the contact of the negative electrode with the electrolyte at a high temperature is reduced to improve the reliability, and also excellent high-rate characteristic and low temperature characteristic can be obtained. Since the negative electrode active material layer 213 has a void between the columnar particles 215, stress produced by expansion and contraction (change in volume) of the active material at the charge and discharge is reduced, and therefore separation of the negative electrode active material layer 213 from the current collector 211 and generation of creases on the current collector 211 can be prevented. Even in the case where the columnar particles expand when absorbing lithium ions and neighboring columnar particles come into contact with each other, the presence of the projecting bodies can reduce the influence by the contact of the neighboring columnar particles with each other and facilitate moving of the electrolyte.

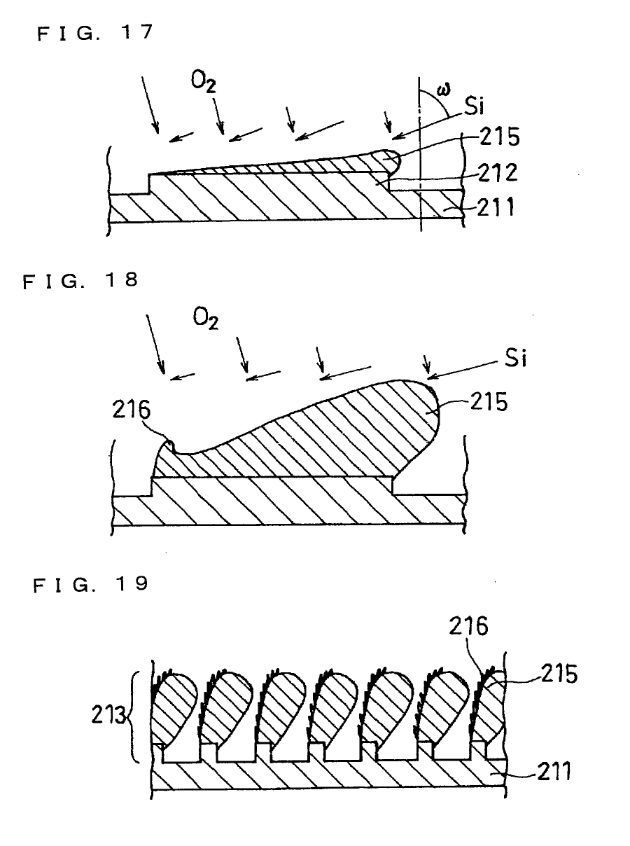

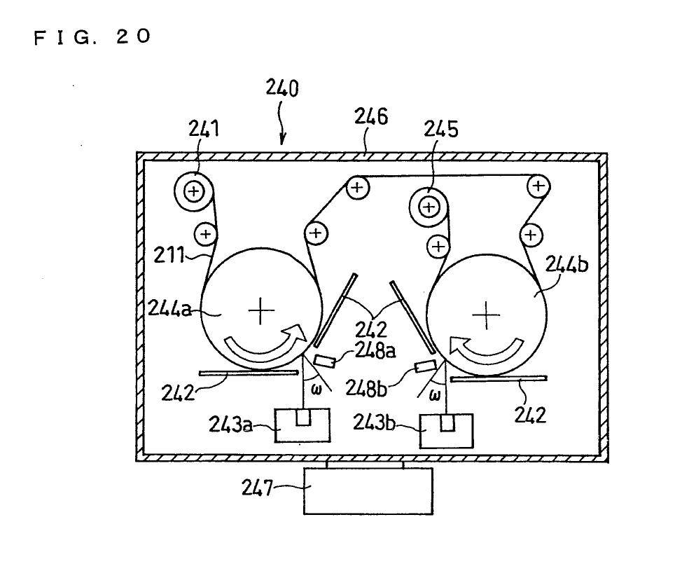

In the following, a manufacturing method of the negative electrode according to this embodiment will be described with reference to FIGS. 16 to 20. FIGS. 16 to 19 are schematic views showing manufacture processes of the negative electrode according to this embodiment. FIG. 20 is a schematic view showing one example of a manufacture apparatus of the negative electrode according to this embodiment. It is noted that a projecting portion 212 of the current collector is enlarged in FIGS. 17 and 18 for easy understanding.

As shown in FIG. 20, a manufacture apparatus 240 comprises a vacuum chamber 246 that can control the atmosphere inside the apparatus 240, an electron beam generating apparatus as a heating means (not shown), a supply roll 241, film-forming rolls 244a and 244b, a take up roll 245, deposition sources 243a and 243b, masks 242, and oxygen nozzles 248a and 248b. Further, a vacuum pump 247 for reducing the inside of the vacuum chamber 246 is connected to the manufacture apparatus 240.

One example of a specific procedure will be described in the following. Herein, one example of forming an active material layer comprising SiOₓ by using Si as the deposition source 243a will be described.

The current collector 211 having the projecting portions 212 on one surface thereof as shown in FIG. 16 is prepared. The projecting portions 212 can be formed by the plating method, for example. As the current collector, a belt-shaped electrolytic copper foil having a thickness of 30 μm is used, for example. The projecting portions 212 are formed with an interval of 15 μm, for example. The current collector 211 is placed on the supply roll 241. As the deposition source 243a, Si (e.g. scrap silicon of 99.999% purity) is prepared. In the downward side of the current collector 211, the deposition source 243a is disposed in the direction of an angle ω (e.g. 60°) with respect to the normal direction of the current collector 211. As shown in FIG. 20, the oxygen nozzle 248a is disposed in a direction other than that of the deposition source 243a, when seen from the center of the film-forming roll 244a (such that an oxygen gas can be incident from an angle of 90° with respect to the incident angle of Si, for example). The inside of the vacuum chamber 246 is adjusted to a prescribed atmosphere (e.g. oxygen atmosphere of pressure of 2×10⁻² Pa).

An electron beam is projected to the deposition source 243a to heat the deposition source and vaporize Si. The vaporized Si is incident from the direction of the arrows in FIG. 17 on the projecting portions 212 on the current collector 211. At the same time, an oxygen gas is supplied from the oxygen nozzle 248a toward the current collector 211 from the direction of the arrows in FIG. 17. By the film-forming roll 244a, the current collector 211 is guided to an area where the range of film forming is restricted with the masks 242. In this area, Si and oxygen gas are supplied to one surface of the current collector. On the current collector, Si and oxygen are bonded to each other to deposit SiOₓ and the columnar particles 215 are formed on the projecting portions 212. At this time, the columnar particles 215 grow inclined with the angle w with respect to the normal direction of the current collector 211.

In FIG. 17, the length of the arrows showing the incident direction of Si and oxygen gas corresponds to the amount of Si and oxygen gas and shows that the shorter the length is, the smaller the amount of incidence is. As shown in FIG. 17, the amount of oxygen gas supplied to the current collector is decreased and the amount of Si supplied to the current collector is increased from left to right at the time of film forming. In this manner, in the columnar particle, the value x can be increased in the surface direction of the current collector 211 from the side forming an acute angle toward the side forming an obtuse angle with the surface direction of the current collector 211. That is, in the columnar particle 215 in FIG. 17, the value x can be increased from right to left. It is noted that such changes in the value x can also be obtained by a shadow effect caused by the fact that the columnar particle is inclined with respect to the normal direction of the current collector.

Further, in the above manufacture method, as shown in FIG. 18, with the growth of the columnar particle, the projecting bodies 216 are formed on the surface of the side forming an obtuse angle with the surface direction of the current collector (surface in which the value x is larger) in the growth direction of the columnar particle 215. In this manner, as shown in FIG. 19, it is possible to obtain a negative electrode 200 comprising a negative electrode active material layer constituted by the columnar particles 215 having the projecting bodies 216 on the projecting portions of the current collector 211.

In this manufacture apparatus, a current collector having a negative electrode active material layer on both surfaces can be formed by using a current collector having projecting portions on both surfaces. In this manufacture apparatus, after the forming process of the negative electrode active material layer on one surface, the forming process of the negative electrode active material on the other surface can be carried out continuously.

As shown in FIG. 20, the current collector 211 with the columnar particles formed on one surface is supplied to the film-forming roll 244b. With the film-forming roll 244b, the current collector 211 is supplied to an area where the film-forming range is restricted by the masks 242. During passing through this area, Si and oxygen gas are supplied onto the current collector from the deposition source 243b and the oxygen nozzle 248b in the same manner as above. The columnar particles are formed on the other surface of the current collector 211. In this manner, the columnar particles having projecting bodies on both surfaces of the current collector are formed. The negative electrode is wound up with the take up roll 245.

It is considered that the projecting bodies 216 are formed by the fact that vaporized Si is bonded or collides with oxygen gas to be scattered at the time of the incidence on the current collector. Therefore, the number, the size, the shape etc. of the projecting bodies per unit area on the surface of the side of the columnar particles forming an obtuse angle with the surface direction of the current collector can be controlled by the degree to which Si is scattered. The formation of the projecting bodies 216 depends on film-forming conditions (e.g. film-forming rate and degree of vacuum). For example, is case the film-forming rate is 10 nm/s or less, the scattering components are increased and only the columnar particles 215 tend to be formed. However, these conditions are not decided absolutely and can be decided appropriately according to other conditions such as the degree of vacuum. Further, as described above, it is considered that the formation of the projecting bodies (scattering of Si) is influenced by the fact that the supply amount of oxygen gas and Si onto the current collector is changed and the introduction direction of oxygen gas is different form the incident direction of Si.

The mechanism that the projecting bodies 216 are formed on the columnar particles 215 is not clear but assumed as follows.

From the deposition source, vaporized particles are incident from above, obliquely with respect to the normal direction of the current collector 211. By this, the columnar particles 215 are formed on the projecting portions 212 of the current collector 11 and an active material layer having a void between the columnar particles 215 are formed. Since the vaporized particles are deposited from above, obliquely with respect to the normal direction of the current collector, in the growth process of the columnar particles 215, a shadow effect by the projecting portions 212 occurs at an early period of the growth of the columnar particles 215, and a shadow effect by the columnar particles 215 themselves occurs at the growth period of the columnar particles 215. By this, the columnar particles 215 grow in the incident direction of the vaporized particles on the projecting portions 212 and the columnar particles 215 inclined to the normal direction of the current collector are formed. Since the vaporized particles do not come flying to the shadow portion made by the columnar particles 215, a void is formed between the neighboring columnar particles 215. Higher the degree of vacuum is and higher the rectilinear characteristic of the vaporized particles is (fewer the scattering components are), this phenomenon occurs more notably.

On the other hand, in case oxygen gas is introduced and the degree of vacuum is low, the vaporized particles that come flying from the deposition source has a short mean free path distance and more components are scattered by bonding or colliding with oxygen gas (components of vaporized particles that move to an angle different from the incident angle). The degree of growth of the projecting bodies can be controlled by changing the proportion of these scattering components.

Most of the vaporized particles that are incident in the growth direction reach the growth surface (tip portion) of the columnar particles and do not reach the side portion of the columnar particles. On the surface in the direction of growth of the columnar particles (tip portion of the columnar particles), even if the scattered components are incident with an angle different from the inclination angle of the columnar particles, most of the vaporized particles of the scattered components are taken into the growth of the columnar particles themselves in the end and become part of the columnar particles.

The scattered components of the vaporized particles reach the side portions of the columnar particles to some degree. Because of the shadow effect of the columnar particles, most of the scattered components of the vaporized particles reaching the side portions of the columnar particles do not reach the side forming an acute angle with the surface direction of the current collector but reaches the side forming an obtuse angle with the surface direction of the current collector. The scattered components of the vaporized particles are much smaller in number than the vaporized particles that are incident in the growth direction of the columnar particles. For this reason, it is considered that the projecting bodies are formed discretely on the side surface of the columnar particles forming an obtuse angle with the surface direction of the current collector.

Since the projecting bodies are formed by the scattered components of the vaporized particles, it is possible to control the shape (size and inclination angle) of the projecting bodies by changing the degree of vacuum, the rate of film forming, the types of introduced gas, the amount of introduced gas and the shape of the projecting portions of the current collector.

In the above embodiment, although the electrode for electrochemical devices is used as the negative electrode for non-aqueous electrode secondary batteries, the present invention is not limited thereto. For example, it is possible to use it in lithium ion capacitors and the same effect as above can be obtained.

### EXAMPLES

Examples of the present invention will be described in the following, but the present invention is not restricted to the following examples.

### Example 1

A stacked-type non-aqueous electrolyte secondary battery as illustrated in FIG. 1 was produced.

### (1) Manufacture of Negative Electrode

Using the plating method, the negative electrode current collector 11 (30 μm in thickness, 300 mm in width) comprising a belt-shaped electrolytic copper foil was obtained. Specifically, a copper foil was immersed in a copper sulfate solution at 50° C., and after a voltage of −1.9 V vs. a copper counter electrode was applied to the copper foil for 30 seconds, a voltage of −0.7 V vs. the counter electrode was applied to the copper foil for 30 seconds. The negative electrode current collector 11 was pressed with rollers having roughness on the surface thereof to form a plurality of belt-shaped projecting portions (7.5 μm in height, 20 μm in width) on both surfaces of the negative electrode current collector 11. At this time, the projecting portions have an interval of 20 μm.

Next, using the manufacturing apparatus comprising an electron beam generating apparatus (not shown) as shown in FIG. 13, a negative electrode active material layer constituted by columnar particles comprising particle layers of 30 steps are formed on both surfaces of the negative electrode current collector.

The fixture stand 43 fixing the negative electrode current collector 11 was installed over the nozzle 45. The angle w of the fixture stand 43 was adjusted to 60°. As the deposition source, a scrap material formed at the time of producing semiconductor wafer (scrap silicon: 99.999% purity) was used. The inside of the vacuum chamber was an oxygen atmosphere of pressure of 6×10⁻³ Pa. The electron beam was projected to the deposition source to vaporize Si. The vaporized Si was deposited on the current collector. At this time, an oxygen gas having a purity of 99.7% was introduced from the nozzle 45 to the inside of the vacuum chamber 41. The particle layer of the first step (0.5 μm in height and 150 μm² in sectional area) was formed at a film-forming rate of about 8 nm/s.

Next, the fixture stand 43 fixing the current collector with the particle layers at the first step was rotated to adjust to the position as shown by the dashed and dotted line in FIG. 13, that is the position where the angle (180-ω) formed between the normal direction of the fixture stand 43 (current collector 11) and the horizontal direction was 120°. Subsequently, the electron beam was projected to the deposition source to vaporize Si. The vaporized Si was deposited on the particle layer 151 of the current collector 11. At this time, an oxygen gas was supplied from the nozzle 45 to the current collector 11.

Then, after the particle layer at the third step, the particle layers at steps of odd numbers were formed under the same conditions as the particle layer at the first step. The particle layers at steps of even numbers were formed under the same conditions as the particle layer at the second step. In this manner, the negative electrode active material layer was constituted by the columnar particles comprising particle layers of 30 steps.

The inclination angle of the respective particle layers with respect to the normal direction of the current collector was measured by using scanning electron microscope (S-4700, manufactured by Hitachi, Ltd.) As a result, the inclination angle of the particle layers at the respective steps with respect to the normal direction of the current collector (i.e. the inclination angle of the first direction and the second direction) was about 41°. The thickness of the negative electrode active material layer (the height of the columnar particles in the normal direction of the current collector) was 15 μm.

As a result of measuring the BET specific surface area of the negative electrode active material by a method described later, the BET specific surface area of the negative electrode active material was 8.0 m²/g.

Using an electron beam probe microanalyzer (EPMA), an oxygen distribution in the sectional direction (sectional direction along the normal direction of the current collector) of particle layers at the respective steps constituting the columnar particles was examined. As a result, it was confirmed that in the respective particle layers, the oxygen concentration (value x) increases continuously, in the surface direction of the current collector, from the side forming an acute angle toward the side forming an obtuse angle with the surface direction of the current collector. Also, the direction in which the oxygen concentration (value x) increases in the particle layers at the steps of odd numbers was opposite to that of the particle layers at the steps of even numbers. Herein, the value x of the respective particle layers was in the range of 0.1 to 2 and the average of the value x was 0.3.

Thereafter, Li metal in the amount corresponding to an irreversible capacity of SiOₓ was deposited on the surface of the negative electrode active material layer by the vacuum vapor deposition method, and a film of Li metal having a thickness of 11 μm was formed on the surface of the negative electrode active material layer. An exposed portion of the current collector was arranged at an edge portion on an inner peripheral side of the negative electrode not facing the positive electrode, and a negative electrode lead made of copper was welded to the exposed portion.

### (2) Manufacture of the Positive Electrode

93 parts by weight of a powder of LiCoO₂ as a positive electrode active material and 4 parts by weight of acetylene black as a conductive agent were mixed. An N-methyl-2-pyrrolidone (NMP) (#1320 manufactured by KUREHA CORPORATION) solution of polyvinylidene fluoride (PVDF) as a binder was added to the obtained mixed powder such that the weight ratio of the mixed powder and PVDF was 100:3, and subsequently an appropriate amount of NMP was added thereto to obtain a positive electrode mixture paste. After the positive electrode mixture paste was applied to both surfaces of the positive electrode current collector made of an aluminum foil (15 μm in thickness) by the doctor blade method, it was dried at 85° C. The positive electrode was rolled such that the density of the positive electrode mixture layer was 3.6 g/cc and the thickness thereof was 160 μm. An exposed portion was arranged at an edge portion on an inner circumferential side of the positive electrode that does not face the negative electrode, and a positive electrode lead made of aluminum was welded to the exposed portion.

### (3) Manufacture of the Battery

The negative electrode and the positive electrode produced as above were stacked with a separator made of microporous polyethylene film having a thickness of 20 μm interposed therebetween to constitute an electrode group. Then, the electrode group was housed in an outer case made of aluminum laminate sheet with an electrolyte. As the electrolyte, a non-aqueous electrolyte prepared by dissolving LiPF₆ at 1 mol/L in a mixed solvent of ethylene carbonate and diethyl carbonate (volume ratio 1:1) was used. In this manner, a battery A1 (designed capacity: 3500 mAh) was produced.

### Example 2

In the manufacture of the negative electrode using the manufacturing apparatus of FIG. 13, a negative electrode was produced in the same manner as in Example 1 except that the inside of the vacuum chamber was an oxygen atmosphere of pressure of 2×10⁻² Pa and that 5 steps of particle layers having a thickness of 4 μm were formed for forming a negative electrode active material layer having a thickness of 20 μm and comprising columnar particles. The BET specific surface area of the negative electrode active material layer was 12.5 m²/g. Using the above electrode, a battery A2 was prepared in the same manner as in Example 1.

### Example 3

A negative electrode was produced in the same manner as in Example 1 except that 2 steps of particle layers of 10 μm were formed for forming a negative electrode active material layer having a thickness of 20μ and comprising columnar particles. The BET specific surface area of the negative electrode active material layer was 50 m²/g. Using the above electrode, a battery A3 was prepared in the same manner as in Example 1.

### Example 4

Using the manufacturing apparatus as shown in FIG. 13, a negative electrode active material layer having a thickness of 10 μm represented by SiOₓ was formed on both surfaces of a negative electrode current collector made of a belt-shaped electrolytic copper foil by the spattering method. Herein, the angle ω was adjusted to 0°. The amount of oxygen gas discharged from the nozzle was adjusted such that the value x in SiOₓ was 0.3. The negative electrode active material layer was formed such that it covered the current collector closely without having a void to which a part of the negative electrode current collector was exposed.

Further, using the sandblasting method, roughness was formed on the surface of the negative electrode active material layer. Specifically, using a compressor, alumina particles were sprayed onto the surface of the negative electrode active material layer with a compressed air having a pressure of 0.15 MPa. The BET specific surface area of the negative electrode active material layer was 5.0 m²/g.

Thereafter, Li metal was deposited on the surface of the negative electrode active material layer by the vacuum deposition method to form a film of Li metal having a thickness of 11 μm on the surface of the negative electrode active material layer. At an edge portion on an inner circumferential side of the negative electrode, an exposed portion of the current collector was arranged at a portion that does not face the positive electrode, and a negative electrode lead made of copper was welded to the exposed portion. Using the above negative electrode, a battery A4 was produced in the same manner as in Example 1.

### Example 5

A negative electrode was prepared in the same manner as in Example 4 except that the pressure of the compressed air in the sandblasting treatment is changed to 0.3 MPa. The BET specific surface area of the negative electrode active material layer was 8.0 m²/g. Using the above negative electrode, a battery A5 was produced in the same manner as in Example 1.

### Example 6

A negative electrode was produced by using the manufacturing apparatus as shown in FIG. 20.

A plurality of belt-shaped projecting portions (7.5 μm in height, 20 μm in width) were formed on both surfaces of the negative electrode current collector 211 made of a belt-shaped electrolytic copper foil (30 μm in thickness, 300 mm in width) by the plating method. Herein, the interval of the respective projecting portions was 15 μm.

The negative electrode current collector 211 was installed on the fixture stand. As the deposition sources 243a and 243b, a scrap material produced at the time of forming a semiconductor wafer (scrap silicon: 99.999% purity) was used. By adjusting the shape of the opening portion of the masks 242, the incident angle ω with respect to the normal direction of the current collector 211 was adjusted to 60°. The inside of the vacuum chamber 246 was an oxygen atmosphere of pressure of 1.5×10⁻² Pa. An electron beam produced by an electron beam generating apparatus (not shown) was projected onto the deposition sources 243a and 243b to heat and vaporize Si, and the vaporized Si was incident onto the current collector 211. The incident direction of oxygen gas was a direction perpendicular to the incident direction of Si. The film forming rate was about 20 nm/s.

Si and oxygen gas were supplied such that the range of the value x was 0.2 to 1.1 and the average of the value x was 0.6 with respect to the surface direction of the current collector 211. Herein, the amount of the oxygen gas supplied to the current collector 211 was increased and the amount of Si supplied to the current collector 211 was decreased from one edge portion (edge portion of the side forming an acute angle with the columnar particles) to the other edge portion (edge portion of the side forming an obtuse angle with the columnar particles) in the width direction of current collector 211. In this manner, the negative electrode was produced.

The negative electrode active material layer was examined using a scanning electron microscope (S-4700, manufactured by Hitachi, Ltd). As a result, a formation of columnar particles was confirmed, and the inclination angle θ₁ of the columnar particles with respect to the surface direction of the current collector was about 50°. The thickness of the negative electrode active material layer (height of the columnar particles in the normal direction of the current collector) was 20 μm. A plurality of projecting bodies (average length: 3 μm, average diameter: 0.5 μm) were formed on the surface of the columnar particles. The inclination angle θ₂ of the projecting bodies 216 with respect to the direction perpendicular to the growth direction of the columnar particles was about 75°. The BET specific surface area of the negative electrode active material layer was 80 m²/g.

Using an electron beam probe microanalyzer (EPMA), the oxygen distribution in the cross section of the columnar particles along the surface direction of the current collector was examined. As a result, it was confirmed that, in the columnar particles, the oxygen concentration (value x) increases continuously from the side forming an acute angle toward the side forming an obtuse angle in the surface direction of the current collector. At this time, the value x in the respective particle layers was in the range of 0.2 to 1.1 and an average of the value x was 0.6.

Subsequently, Li metal was deposited on the surface of the negative electrode active material layer by the vacuum deposition method to form an Li metal layer having a thickness of 11 μm on the surface of the negative electrode active material layer. Thereafter, on an inner circumferential side of the negative electrode, an exposed portion of 30 mm was arranged on a Cu foil that does not face the positive electrode and a negative electrode lead made of Cu was welded thereto.

Using the above negative electrode, a battery A6 was produced in the same manner as in Example 1.

### Example 7

In the manufacture of a negative electrode using the manufacturing apparatus of FIG. 20, a negative electrode was produced in the same manner as in Example 6 except that the inside of the vacuum chamber was an oxygen atmosphere of pressure of 6×10⁻³ Pa. The BET specific surface area of the negative electrode active material layer was 50 m²/g. Using the above negative electrode, a battery A7 was produced in the same manner as in Example 1.

### Comparative Example 1

A negative electrode was prepared in the same manner as in Example 4 except for not carrying out the sandblasting treatment. The BET specific surface area of the negative electrode active material layer was 4.3 m²/g. Using the above negative electrode, a battery B1 was produced in the same manner as in Example 1.

### Comparative Example 2

The columnar particles on the negative electrode produced in the same manner as in Example 6 was further subjected to an etching treatment to form roughness on the entire surface of the columnar particles. As an etching liquid, a hydrofluoric acid was used. Herein, the BET specific surface area of the negative electrode active material layer was 250 m²/g. Using the above negative electrode, a battery B2 was produced in the same manner as in Example 1.

Evaluations as described below were carried out with the respective batteries produced in the above.

[Evaluations]

(1) Measurement of Bet Specific Surface Area of Negative Electrode Active Material Layer

At the time of producing the respective negative electrode in the above, the BET specific surface area of the negative electrode (negative electrode active material layer at an early period) was measured. After deaerating the negative electrode for 2 hours at 100° C., the BET specific surface area was measured using a measuring apparatus (ASAP 2010, manufactured by MICROMERITICS). The measurement pressure range was 0 to 127 KPa. The adsorption element was Kr.

After the manufacture of the battery, each battery (designed capacity: 3500 mAh) was charged at a constant current of 1.0 C (3500 mA) until the battery voltage reached 4.2 V, and then charged at a constant voltage of 4.2 V until the charge current value decreased to 0.05 C (175 mA). The charged battery was dissembled and the negative electrode was taken out, and the BET specific surface area of the negative electrode in the charged state (negative electrode active material layer after the charge) was also measured.

(2) Evaluation of High-Rate Characteristic

Under an environment of 25° C., after each battery (designed capacity: 3500 mAh) was charged at a constant current of 1.0 C (3500 mA) until the battery voltage reached 4.2 V, the battery was charged at a constant voltage of 4.2 V until the charge current value decreased to 0.05 C (175 mA). After a rest of 30 minutes, the battery was discharged at 0.2 C (700 mA) until the battery voltage reached 3.0 V, and a discharge capacity A was determined.

Next, under an environment of 25° C., after each battery was charged at a constant current of 1.0 C (3500 mA) until the battery voltage reached 4.2 V, the battery was charged at a constant voltage of 4.2 V until the charge current value decreased to 0.05 C (175 mA). After a rest of 30 minutes, the battery was discharged at 2 C (7000 mA) until the battery voltage reached 3.0 V and a discharge capacity B was determined.

The ratio (percent) of the discharge capacity B to the discharge capacity A was determined as a high-rate characteristic (%).

(3) Evaluation of Low-Temperature Characteristic

Under an environment of 25° C., each battery (designed capacity: 3500 mAh) was discharged at 0.2 C (700 mA) until the battery voltage reached 3.0 V, thereby to determine an initial discharge capacity C.

Next, under an environment of 0° C., after each battery was charged at a constant current of 1.0 C (3500 mA) until the battery voltage reached 4.2 V, the battery was charged at a constant voltage of 4.2 V until the charge current value decreased to 0.05 C (175 mA). After a rest of 30 minutes, the battery was discharged at 0.2 C (700 mA) until the battery voltage reached 3.0 V.

After these charge and discharge were repeated for 10 times, the battery was charged again under an environment of 25° C. at a constant current of 1.0 C (3500 mA) until the battery voltage reached 4.2 V, and then charged at a constant voltage of 4.2 V until the charge current value decreased to 0.05 C (175 mA). After a rest of 30 minutes, the battery was discharged at 0.2 C (700 mA) until the battery voltage reached 3.0 V, and a discharge capacity D after 10 cycles of the charge and discharge under an environment of 0° C. was determined.

The ratio (percent) of the discharge capacity D to the discharge capacity C was determined as a low-temperature characteristic (%).

(4) Evaluation of Heat Resistance

After each battery was charged under the same conditions as above, a rest of 30 minutes was taken.

Subsequently, the battery was dissembled, the negative electrode was taken out of the battery and washed with ethyl methyl carbonate, and the negative electrode active material was collected. Then, 1 mg of the negative electrode active material was introduced into a vessel made of SUS and 1 mg of an electrolyte was added thereto. As the electrolyte, a solution of LiPF₆ dissolved at a concentration of 1 mol/L in a mixed solvent of ethylene carbonate and diethyl carbonate (volume ratio 1:1) was used. After the vessel was sealed, in an argon atmosphere, a differential scanning calorimetry (DSC) was carried out using TAS 300 manufactured by Rigaku Corporation. On the basis of the measurement results thereof, the amount of generated heat (J/g: amount of generated heat per 1 g of negative electrode active material in charged state) was determined in the range of 100 to 200° C. and the heat resistance was evaluated.

The evaluation results are shown in Table 1.

TABLE 1

| | | | | | | BET specific | BET specific | | | |
|---|---|---|---|---|---|---|---|---|---|---|
| | | Negative | | Thickness | Number of | surface area of | surface area of | | Low- | |
| | | electrode | Form of | of negative | steps of | negative active | negative active | High-rate | temperature | Amount of |
| | | active | negative | active material | particle | material layer | material in charged | character- | character- | generated |
| | Battery | material | electrode | layer (μm) | layers | (m²/g) | state (m²/g) | istic (%) | istic (%) | heat (J/g) |
| Ex. 1 | A1 | SiO_{0.3} | Formation | 15 | 30 | 8 | 1.7 | 84.5 | 91.5 | 142 |
| | | | of particle | | | | | | | |
| | | | layers | | | | | | | |
| Ex. 2 | A2 | SiO_{0.6} | Formation | 20 | 5 | 12.5 | 2.3 | 85.0 | 92.0 | 160 |
| | | | of particle | | | | | | | |
| | | | layers | | | | | | | |
| Ex. 3 | A3 | SiO_{0.6} | Formation | 20 | 2 | 50 | 3.5 | 88.2 | 93.1 | 212 |
| | | | of particle | | | | | | | |
| | | | layers | | | | | | | |
| Ex. 4 | A4 | SiO_{0.3} | Blasting | 10 | 1 | 5 | 0.1 | 81.3 | 86.2 | 110 |
| | | | treatment | | | | | | | |
| Ex. 5 | A5 | SiO_{0.3} | Blasting | 10 | 1 | 8 | 1.5 | 84.1 | 90.9 | 151 |
| | | | treatment | | | | | | | |
| Ex. 6 | A6 | SiO_{0.6} | Formation | 20 | 1 | 80 | 5 | 87.5 | 92.6 | 240 |
| | | | of columnar | | | | | | | |
| | | | particles | | | | | | | |
| | | | and | | | | | | | |
| | | | projecting | | | | | | | |
| | | | bodies | | | | | | | |
| Ex. 7 | A7 | SiO_{0.3} | Formation | 20 | 1 | 50 | 3.4 | 87.7 | 92.8 | 220 |
| | | | of columnar | | | | | | | |
| | | | particles | | | | | | | |
| | | | and | | | | | | | |
| | | | projecting | | | | | | | |
| | | | bodies | | | | | | | |
| Com. | B1 | SiO_{0.3} | No blasting | 10 | 1 | 4.3 | 0.08 | 72.5 | 78.5 | 98 |
| Ex. 1 | | | treatment | | | | | | | |
| Com. | B2 | SiO_{0.6} | Etching | 20 | 1 | 250 | 8.6 | 88.9 | 95.2 | 1200 |
| Ex. 2 | | | | | | | | | | |

In the batteries A1 to A7 in which the BET specific surface area of the negative electrode active material layer was 5 m²/g or more and 80 m²/g or less, the amount of generated heat was small and a good safety, high-rate characteristic and low-temperature characteristic were obtained.

In the battery B1 in which the BET specific surface area of the negative electrode active material was less than 5 m²/g, although the amount of generated heat was small, the high-rate characteristic and the low-temperature characteristic decreased. The reason for this is considered that since the surface area of the active material layer was small, the reaction resistance by the desorption reaction of lithium from the negative electrode was high.

In the battery B2 in which the BET specific surface area of the negative electrode active material layer was more than 80 m²/g, although about the same degree of high-rate characteristic and low-temperature characteristic as the battery A3 were obtained, the amount of generated heat increased. This is considered that since the specific surface area of the active material layer was large, the reaction of the active material with the electrolyte under a high-temperature environment was intense.

It is to be noted that, although SiOₓ was used as the active material in the above Examples, the similar results as above can be obtained as long as an element which can reversibly absorb and desorb lithium ions is used. For example, Si and at least one element selected from the group consisting of Al, In, Zn, Cd, Bi, Sb, Ge, Pb and Sn can be used. Also, the active material may contain other elements than above.

### INDUSTRIAL APPLICABILITY

The electrochemical device according to the present invention has a high capacity and at the same time is excellent in high-rate characteristic, low-temperature characteristic and safety, and therefore it can be suitably used as a power source for portable equipment such as mobile phones and PDAs, as well as for electronic equipment such as information equipment.

1. An electrode for an electrochemical device comprising a current collector and an active material layer formed on said current collector,
said active material layer comprising an active material which can reversibly absorb and desorb lithium ions and has a theoretical capacity of more than 833 mAh/cm³, and
the BET specific surface area of said active material layer being 5 m²/g or more and 80 m²/g or less.

2. The electrode for an electrochemical device according to claim 1, wherein the BET specific surface area of said active material layer in the charged state is 0.1 m²/g or more and 5 m²/g or less.

3. The electrode for an electrochemical device according to claim 1,
wherein said current collector has a projecting portion on a surface thereof, said active material layer comprises at least one columnar particle, and said columnar particle is formed on said projecting portion.

4. The electrode for an electrochemical device according to claim 3, wherein said columnar particle is inclined with respect to the normal direction of said current collector.

5. The electrode for an electrochemical device according to claim 3, wherein said columnar particle comprises a stack of particle layers, and said particle layers are inclined with respect to the normal direction of said current collector.

6. The electrode for an electrochemical device according to claim 5, wherein the BET specific surface area of said active material layer is 8 m²/g or more and 50 m²/g or less.

7. The electrode for an electrochemical device according to claim 5, wherein particle layers at steps of odd numbers counted from a bottom portion of said columnar particle are inclined toward a first direction with respect to the normal direction of said current collector, and
wherein particle layers at steps of even numbers counted from a bottom portion of said columnar particle are inclined toward a second direction with respect to the normal direction of said current collector.

8. The electrode for an electrochemical device according to claim 4, wherein said columnar particle comprises a plurality of discrete projecting bodies formed on the surface of a side forming an obtuse angle with the surface direction of said current collector.

9. The electrode for an electrochemical device according to claim 8, wherein the BET specific surface area of said active material layer is 50 m²/g or more and 80 m²/g or less.

10. The electrode for an electrochemical device according to claim 4, wherein the angle with which said columnar particle is inclined in an acute angle with respect to the surface direction of said current collector is enlarged as lithium ions are absorbed in said columnar particle.

11. The electrode for an electrochemical device according to claim 5, wherein the angle with which said particle layers are inclined in an acute angle with respect to the surface direction of said current collector is enlarged as lithium ions are absorbed in said particle layers.

12. The electrode for an electrochemical device according to claim 1, wherein said active material comprises a compound represented by the general formula: SiOₓ (provided that 0<x<2).

13. The electrode for an electrochemical device according to claim 4, wherein said columnar particle comprises a compound represented by the general formula: SiOₓ (provided that 0<x<2), and said value x in said columnar particle increases, in the surface direction of said current collector, from a side forming an acute angle toward a side forming an obtuse angle with the surface direction of said current collector.

14. The electrode for an electrochemical device according to claim 5, wherein said columnar particle comprises a compound represented by the general formula: SiOₓ (provided that 0<x<2), and said value x in said particle layers increases, in the surface direction of said current collector, from a side forming an acute angle toward a side forming an obtuse angle with the surface direction of said current collector.

15. The electrode for an electrochemical device according to claim 1, wherein the surface of said active material layer is subjected to a sandblasting treatment.

16. The electrode for an electrochemical device according to claim 15, wherein the BET specific surface area of said active material layer is 5 m²/g or more and 8 m²/g or less.

17. An electrochemical device comprising an electrode according to claim 1.

18. The electrochemical device according to claim 17, wherein said electrochemical device is a non-aqueous electrolyte secondary battery comprising a positive electrode, a negative electrode and a non-aqueous electrolyte, and at least one of said positive electrode and said negative electrode is said electrode.
